(19) United States
(12) Patent Application Publication
(10) Pub. No.: US 2023/0274314 A1
(43) Pub. Date: Aug. 31, 2023

(54) Metaverse room interacting with a search engine

(71) Applicant: Wesley Job Boudville, Altadena, CA (US)

(72) Inventor: Wesley Job Boudville, Altadena, CA (US)

(21) Appl. No.: 17/803,127

(22) Filed: Feb. 28, 2022

(51) Int. Cl. G06Q 30/02; G06F 3/04817; G06T 19/00; G06F 3/04815; H04N 13/204

(52) U.S. Cl. CPC G06Q 30/0253; G06Q 30/0277; G06F 3/04817; G06T 19/006; G06F 3/04815; H04N 13/204

(57) ABSTRACT

Interactions between a room in the Metaverse and a spider visiting the room are described. When the spider views a VR scene, it is made by the room at the FoV of the spider. The room inserts an ad. If the spider removes the ad, the room detects this and refuses the spider future visits. In VR, there is a balance of power between the room and a spider.

### TECHNICAL FIELD

Augmented reality, virtual reality and Metaverse

### BACKGROUND

Augmented reality (AR) and virtual reality (VR) have grown substantially. This led to predictions of a “Metaverse”, notably by FACEBOOK CORP, which has rebranded as “META”. The Metaverse is a simulated 3d environment in which a so-called “Web 3.0” might happen.

There is much activity on making new hardware Heads Up Displays (HUDs) in which to view and take part in the Metaverse. For example, FACEBOOK bought Oculus and is making new Oculus HUDs. GOOGLE is emphasising AR HUD development, inspired by the success of Pokemon Go, a game made by NIANTIC. The latter is a joint venture between GOGGLE and NINTENDO.

In the rush to the Metaverse, there has been an overlooking of some basic problems. These include zombie avatars and the problems tackled in the current submission. (In a previous co-pending submission, we described the problem of zombie avatars and methods to address these.)

### BRIEF DESCRIPTION OF THE DRAWINGS

FIG. 1 shows a VR room with avatars and objects.

FIG. 2 shows a spider following an avatar and seeing a first person view.

FIG. 3 shows a map of an avatar's path thru a VR room.

FIG. 4 shows a “focal point” symbol of a ghost spider.

FIG. 5 shows a common “focal point” for 3 ghost spiders at the same location.

FIG. 6 shows an avatar recording video and audio, with indicators on.

FIG. 7 shows the room inserting an ad into a data stream sent to the spider.

FIG. 8 shows the room replacing an ad in the spider's data.

FIG. 9 is a flow chart of an advertiser interacting with a user.

FIG. 10 is a timeline of what a user sees in the VR room.

### REFERENCES

“Contextual templates for modifying objects in a virtual universe” by Finn et al. #20100177117, 14 Jan. 2009. https://9to5mac.com/2022/01/04/report-apples-upcoming-ar-vr-headset-will-feature-innovative-three-display-configuration/

### DETAILED DESCRIPTION OF THE PREFERRED EMBODIMENT

What we claim as new is set forth in the following.

This application has the following sections:

1: Basics;

2: Bookmarks;

3: Calendar;

3.1: Incognito;

4: Surveillance;

5: AR and VR interaction;

6: Metaverse Spider;

7: Inserting ads in Spider data;

8: Antispam;

### 1: BASICS

Let Doris be a user. She has an avatar Alpha. She is wearing an AR/VR Heads Up Display (HUD) rig. She picks a Metaverse “room” to enter, while “wearing” her avatar Beta. The picking of the room is done by various means. One can be that she has an URL of the room. The URL is shown in her Field of View (FoV) while wearing the rig. She picks the URL by some means made available to her by the rig. The intent is that the picking will lead to her avatar “following” the URL, so that it (and her) will appear in the room.

What we call a room might a representation of a room, with her appearing inside a likely rectangular room. But the room might instead be shown as an open air area, potentially infinite in size. This might correspond to the surface of a planet. For convenience we use “room” with the understanding that it could be instead an open area.

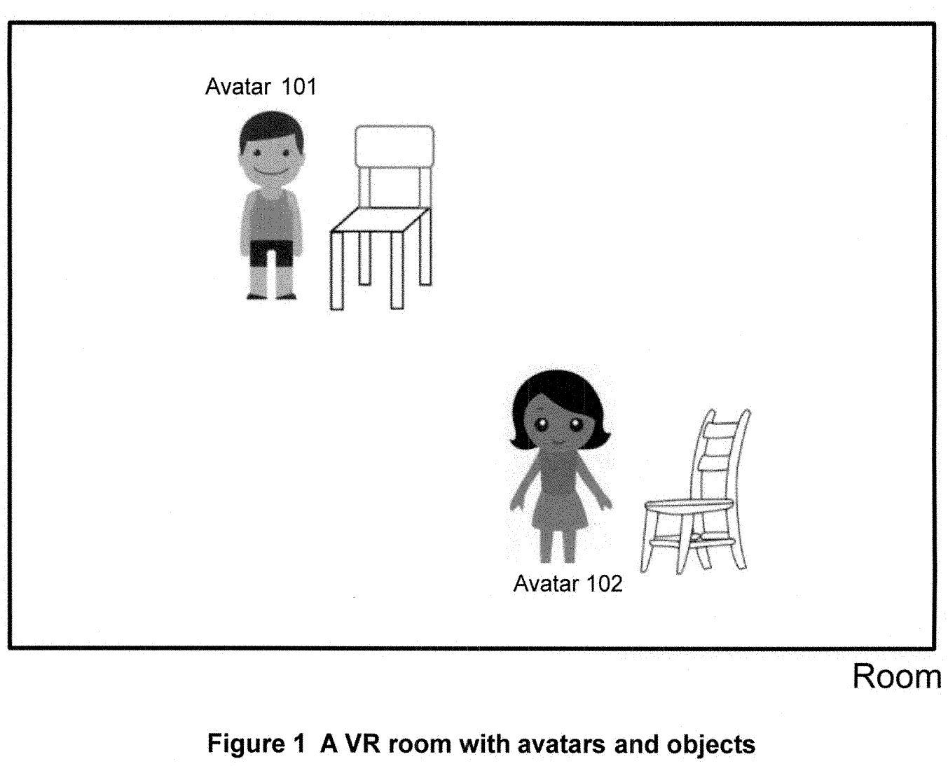

FIG. 1 shows such a room. Inside it might be plants, furniture and perhaps already avatars. When Doris picks the room, and this is before her avatar moves to it, she does not know where in the room it (and her) will appear. Perhaps she has never been to the room before. Or even if she had, where she appears can vary each time.

She can make her request in various ways. She might say it, if her rig has the means to hear it. Or in her FoV there could be a pop up menu of choices. She can scroll thru these and pick a choice. Or before putting on her rig, she can type her request in some other computer, like a laptop. She would be running a program on it that conveys her request to the rig and thence to the room server.

She might not have to do this every time she goes to that room. There could be default choices made by her or by the room. Also, different rooms are assumed to be run by different firms. The default choices made by a room might differ from those made by a second room. The second room can be run by a different firm or indeed by the firm who runs the first room.

What preferences can she have? Suppose none. So the room can randomly pick a location for her avatar Beta. This location cannot be too close to any avatar already in the room. The room might impose a proximity condition that says Beta cannot be within (eg) 2 meters of another avatar. This could be as an anti-sexual harassment method imposed by the room, for example. The room can just pick a random location, subject to this constraint, and put Beta there.

What if the room is an outdoor area of (say) 20 km×30 km? A random location might place Beta out of a line of sight of any other avatar. This might not be desirable. Beta (nee Doris) might want to be able to see another avatar nearby and perhaps to decide to walk to it. Also, suppose the terrain has hills or trees. This might hide an existing avatar from Doris. She might think she is alone in the virtual world. This might not be desirable (if there are other avatars). This can be a drawback is if Doris goes to the room to interact with others.

Thus a random placement of Doris/Beta has a nuance. It might be random but within line of sight of another avatar (if it exists).

Doris might have a preference option for “crowd”. Or this could be a room default option. This means the room will try to put her near as large a crowd of avatars as it can find.

She lands in the room and moves around, interacting with others. Eventually she decides to leave. Later, she goes back to the room. She might pick “last location”. This means the room will try to put her back in the last location she was at, subject to an overriding constraint about not being too close to another avatar. Another choice she could make is “first location”. This means she will appear at the same place that she first appeared in the room. (Subject to a proximity constraint.)

Or in an earlier visit to the room, she saw a gazebo. Now when re-entering the room, she might type or say “gazebo”. The room can try to find a gazebo in it, and which was visited by her. If there are several gazebos, it can pick the one that was visited by Doris. If she had never been to any of the gazebos, the room can just pick one and put her there.

Another option is for Doris to pick a “loner” option. The room will try to place her by herself; ideally with no others nearby.

Another option is for Doris to say that she wants to have the only avatar wearing (eg) bowler hat, like “only person wearing bowler hat”. Since the room has already scanned all the avatars presently in the room, it can quickly search and use image recognition to try to satisfy this requirement.

Another way is Doris might ask for “fountain” or “lion or fountain”, before she appears in the room. This has the room search for those items and if successful, jump to a location near those. The room does image recognition of avatars and Non Player Characters (NPCs) to try to find the requested objects.

As a practical matter, for objects in the room that do not move, like a fountain, the room can make a list of them, with a location for each. This reduces the need to do image recognition to find a fountain, for example. Searching for this reduces to a textual search of a small list. Very rapid.

Doris can also ask for the name of an avatar, like “Green Dragon” or “Todd”. This might be rejected by the room if it does not permit such searching. This can be a purely textual search. Or not. “Todd” might cause the room to search for audio spoken with that term. If so, Doris is sent to be near avatars speaking about Todd.

Doris can ask for a specific type of interaction between avatars, like “sword fight” or “horse racing” or “poker”. This triggers the room to search for the interaction and if found, sends Doris to it inside the mom.

For each of the above, there can be also a weak form of the condition. This says try to achieve the condition, but if not, then do a best effort. What the latter means can be left to the room.

### 2: BOOKMARKS

We now use the metaphor of visiting webpages. When Doris is in the room, she wanders thru it. She can “bookmark” locations in the room. At each location, when she does “bookmark”, at least 2 things can happen. She can label the bookmark with a title that is meaningful to her, like “fountain” or “coffee shop”.

The label might be audio. Or a combination of text and audio. The audio part of the label might include a recorded tune, perhaps furnished by the owner of the fountain or coffee shop. The tune might be done to enhance Doris' memory of the place.

There can be a haptic option, if her rig has the means of simulating touch of an object. She can choose a haptic label, that corresponds to how a given object felt to her. She does this when she is close to the object or place. Then later when she picks this label, her rig will transport her to that object.

She can also store an image (“photo”) of the place. This can help jog her memory at a later time. The image can be a standard image taken from her FoV. It could be a subimage, where she looks at just a part of the overall image. Or the image could be a stereoscopic 360 degree view. This is easy to do in the context of the VR room. She might be able to store several images at that location.

A variant is when some of the images are not taken by her (ie. from her FoV). Instead, an image could be furnished by the location itself. Perhaps to emphasize a professionally taken image.

Whether she takes the image or not, once she has it, she can use graphical methods to annotate it. Perhaps to make it more useful for her to remember.

Underneath these are the coordinates. First would be the coordinates of the entire room. Likely this can be an URL. But in the room, there would be a coordinate grid of some kind. This is used to give the coordinates of the place in the room that she bookmarked. Just like bookmarks for webpages, these coordinates are necessary, but the meaningful data are the label and the photos.

We are using “bookmark” as a second level metaphor. The now standard use of “bookmark” is itself a metaphor. A real bookmark is when you have a (real) book and you crease the corner of a page lo make a bookmark. Or perhaps insert a piece of cardboard at that page. The web bookmark of a webpage is a metaphor that builds on the physical case. We extend that here.

### 3: CALENDAR

A related concept to bookmarking is a calendar. Suppose within the room that Doris visits, she finds a group of avatars and they are planning a poker game next week at a given location in the room. She can take photos of the location and put these into her calendar for the poker event. She can also write the day and time of the event into the calendar. When the event approaches temporally, her calendar sends her reminders. This thus far is just a normal calendar, so this can be integrated into her daily calendar.

In the minutes just before the event, the calendar can use the location in the Metaverse and put it before her. It can remind her to use her HUD rig. Then when she has done so, she can jump to the event and watch or lake part.

The reminder can also be done if she is currently in another room of the Metaverse. She gets an alert (in audio or on her rig) from a version of the calendar that runs in the Metaverse. The alert has a link to the event. If she clicks the link, she is transported there.

There is an issue about avatars. Suppose Doris has several avatars. When she signs up for an event, and she does this in a Metaverse room, the calendar can record which avatar she is using. When later she gets a reminder in the Metaverse, just before the scheduled event is to happen, this can include a reminder of what avatar she was using earlier. This could be germane to the event. Then if she clicks on the event, this can put her into that avatar before sending her to the event.

One reason could be to remind others, who are using avatars, who she “is”, when she appears at the event. Earlier when she signed up, she wore an earlier avatar, and that would be likely recognised when she appears.

Continuing, there can be an id step when if she uses an avatar unknown to the event, she is taken to a “lobby” room of the event room. She might be manually scrutinised by an organizer in order to be admitted. Or this lobby room might just be a holding area, where her current avatar is scanned by the event room. The latter keeps images of visitors and compares her avatar against those.

### 3.1: Incognito

While avatars can give some anonymity, if a user uses the same avatar for some time, then the avatar itself becomes recognisable. This can give rise to rooms like an “Incognito” room. A user with an avatar who goes to this can (or has to) assume a new avatar. The room can have a means to let visitors quickly generate these avatars. When visitors leave, they assume their previous avatars.

Take this further. Suppose Doris with an avatar goes to an Incognito room and assumes a temporary avatar Ralph. She leaves the room. A few days later, she returns to it. The room can remember Ralph and her avatar for outside the room. Even without anything else, by image recognition, when she enters the room, it can offer her Ralph. Or it might let her get another avatar.

The Incognito room might admit each user separately, so the user's avatar (outside the room) is unknown to other users in the room. An exception can be made for couples or groups where the users already know each other's avatar.

An Incognito room might have a policy to always make new avatars, for single use only. Or it might let an avatar be reused. If so, the avatar might be reused only for the same user. Or it might be reused for any user. Different Incognito rooms can have different policies.

### 4: SURVEILLANCE

Metaverse can be well suited for surveillance. In a VR room, spoken interaction between avatars must be processed by the room. This audio can be digitised by the room and analysed for sensitive terms on behalf of law enforcement.

Largely, surveillance seems moot. Two users, using avatars and the users being physically separated, can easily evade any surveillance by the room in which their avatars are in. They get burner phones in real life and communicate with each other. Then in the VR room, suppose 1 player is in a poker game. And the second person's avatar is in the audience. If the latter avatar can see some of the cards of the other players, he can communicate this to the first player via various means in real life. Like electronic messages. Or using the phones.

Thus we suggest trial gambling games will be difficult to implement in the Metaverse, if these are being played for non-trivial amounts of money.

### 5: AR AND VR INTERACTION

Doris is in a VR room and she wears a VR rig. She interacts with Bob, who is running an AR app on his mobile device. There is some way they can communicate via their devices. Bob's app shows an overlay on the real world. He might be doing a scavenger hunt. His app finds virtual items overlaid on certain real world locations. (Like Pokemon Go.) He finds a virtual item and sends it to Doris. The item might change form since it now is in a different app. Doris compensates Bob by paying him money or some artificial currency. Or their combined game might require her to find in her VR room a virtual item, and then send this to Bob, which he needs to play his game.

### 6: METAVERSE SPIDER

Consider Doris with her avatar Beta. She is considering entering a given VR room. Currently she is in another room, or entirely outside the Metaverse and she is wearing her VR rig and she has spun up Beta. She might be looking thru Beta's FoV. But before she goes into the new room, she uses a spider. She searches for that room and sees that the spider's results are.

When we use the term “spider”, we mean a modification of a conventional search spider to search VR rooms and the Metaverse. Currently, the 2 best known search spiders in the US are those made by GOOGLE and MICROSOFT. But the methods and capabilities attributed here to a Metaverse spider can be done by a separate program, which is unrelated to a conventional search spider.

She can see the spider's record of the avatars in the room. On earlier days and perhaps earlier today, the spider crawled the room and took snapshots and snippets of video of the room and its occupants. Doris looks at these and tries to decide if the room is interesting enough to visit. The snippets can include audio and video and haptic data. Doris can see or feel what the spider recorded.

The spider may have controlled an avatar (if this is allowed by the room's rules), and used it in an automated way to move in the room and record the activities of others. Or the spider may have not used an avatar. In this case, the spider is termed a “ghost spider”. It is a computer program adapted to search the room but, like a conventional search spider, does not use a visible form of an avatar to do so.

A new use of our spider is where a user hires the spider. The user has an avatar and this goes thru the room, interacting with others. Or the user's avatar might just typically record what it sees and hears. The user asks the spider to follow it, in the first person view. This means that the spider looks out thru the user avatar's eyes and it hears thru the user avatar's ears. In this configuration, the spider does not need its own avatar, if it was even using one earlier. From the visual and aural feed, the spider records it for the user. The spider might be paid to do this. The feed can be copied to the user, letting her have a record of her journey.

The spider can also record what the user avatar feels, if the avatar has haptic sensors. The haptic data can be added to the visual and aural data.

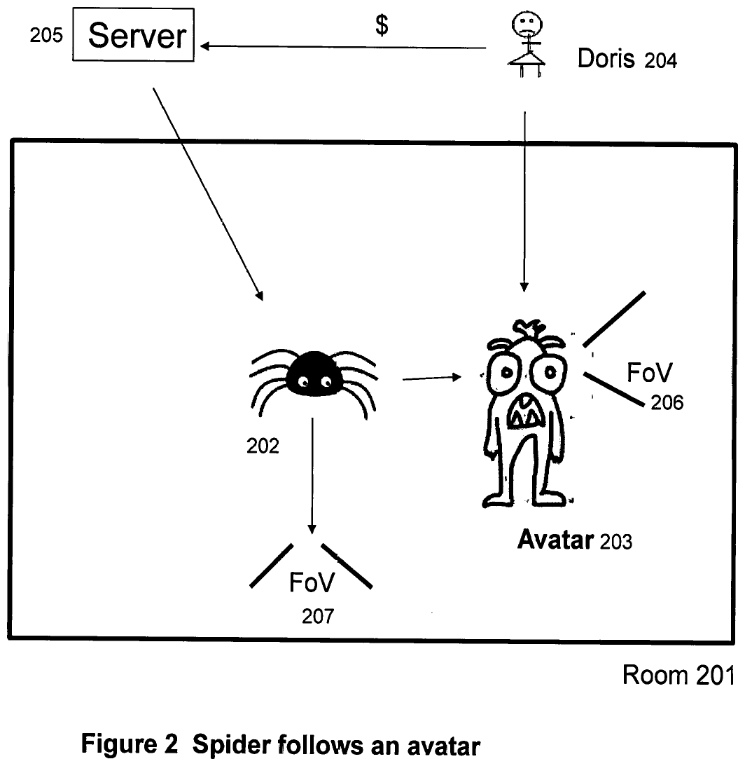

The spider might store snippets or the entirety of the feed, to be searchable and visible to others. This might be allowed by the user. Or it might be required by the spider, for the user to agree to this, before the spider began recording. See FIG. 2. Spider 202 is following Doris' avatar 203. The avatar has a first person PoV 206. There is the possibility that Doris 204 pays the spider server 205 for this service.

A third person method can be used by the spider, where it follows the user's avatar, and sees the user's avatar at a short distance.

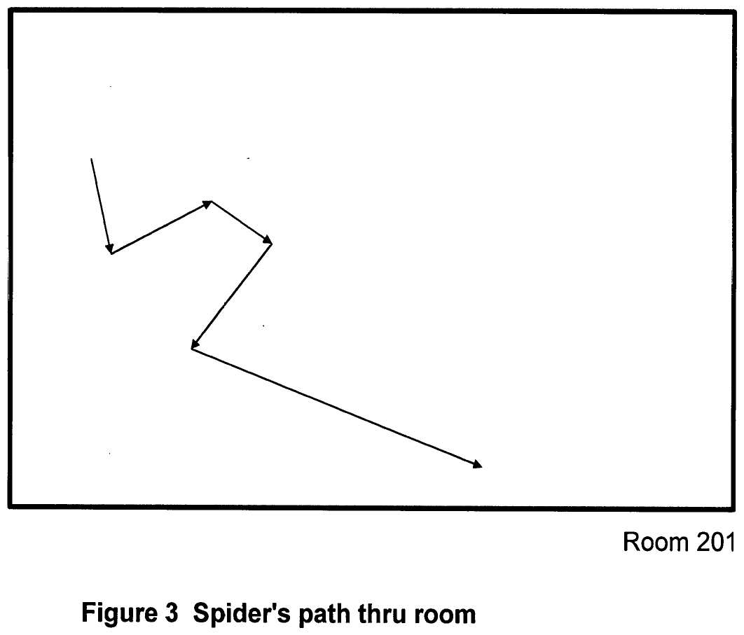

The first and third person methods can also show the user's avatar's path on a map of the room. For example, see FIG. 3.

One possibility is that the functionality of the spider is done by the room itself, as it has the data on the paths of the avatars and the visuals of the avatars and the voices. But an objection is that a spider run by the room can censor or alter the collected data, giving rise to doubts about its validity. Experience with the Web spiders run by GOOGLE and MICROSOFT is that by being external to the websites, the Web spiders collect data that is trusted by end users. This cannot be assumed for the Metaverse.

For example, one problem is zombie avatars. These are avatars made and then left for hours in a room, under no active control. It is a way for the room to buff up its usage statistics. Spiders can be used to detect zombies. But a spider run by a room has no incentive to do so. We discussed this in an earlier co-pending application “Ghost spiders and zombie avatars of the Metaverse”.

There may be privacy considerations with the use of a spider. Unlike a Web page, a Metaverse room can have several users interacting live with each other. A room might have a policy for a spider to only record visual information, and not store audio conversations. This lets the room store text messages going between the avatars.

A room can have a smaller room within it. Users who enter the small room can have private discussions, unrecorded by the room or spiders. A record of which avatars enter the room can or might not be made. But this has to be stressed. When 2 people in real life sit next to each other and talk softly, that conversation is hard for others to hear. But when 2 users talk thru their avatars in a VR room, the vocals are made to into microphones on the users' rigs. These vocals go to the room server, which routes them to We other person's avatar. The room server inherently gets all conversations by all users. The server can readily record these, without any special listening equipment as in real life. Thus authorities can put a tap on any conversations.

A room can have a policy of not storing any conversations. So an existing tap can be done on conversations yet to happen. But past conversations are gone.

A problem with the room policy of not storing conversations is if this is not believed by (some) users. Related to this is a scenario where the government orders a room to record a conversation via avatars, and orders the room not to tell users that the room is doing this.

If there are 2 users, Doris and Bob, that already know each other, they can communicate by various other means, without having to go thru their avatars in a VR room. Instead of coming up with a way to do an encrypted-type conversation in the room, they should just talk via some type of VPN means.

A VR room can have a policy that it does not record any conversation. And it can (try to) charge more to visitors because of this.

Consider a VR room with avatars in it and a spider that enters the room. Depending on the number of avatars and what they might be doing, the spider might spawn copies of itself to record the activity in the room. And the copies might persist for longer, in doing so.

For example, if the avatars are watching one avatar in the room, which might be dancing in front of them or talking to them, a spider might decide to only spawn a few copies to record. Especially if the watching avatars are just standing still.

But if the avatars are in (eg) 5 different groups, each group largely interacting by itself, then the spider could spawn 4 spiders, and the resulting total of 5 spiders would each take a group to record.

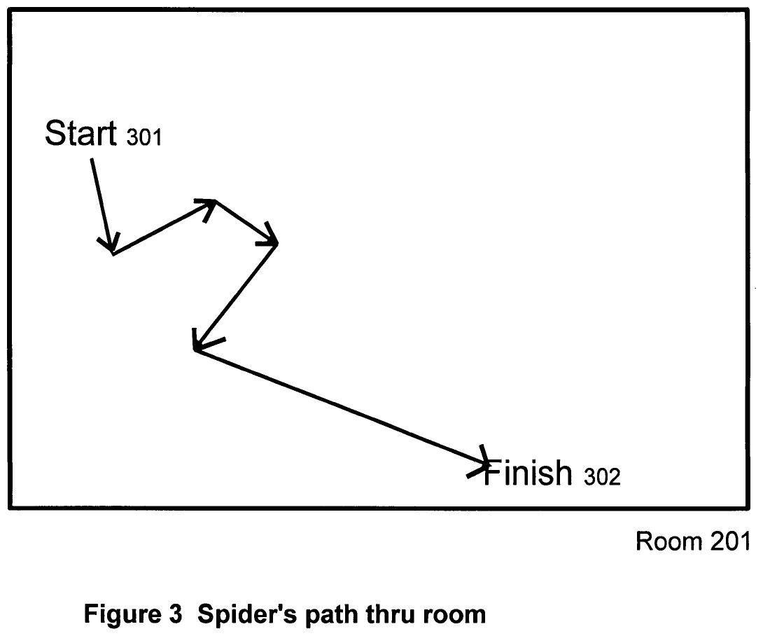

A room might have a policy that a spider in the room can be a ghost spider; it does not need to have an avatar. But the ghost spider must instantiate a visible signal, like a blinking light, at the location of its “focal point”. This is analogous to, in the United States, where a truck backing up issues a beeping sound, to alert pedestrians that the truck is doing so, and to warn them to be careful. The focal point symbol might be as shown in FIG. 4, a 3 dimensional cone, where the point of the cone represents the geometric focal point, and the cone is the Field of View. In this example, the ghost spider might be near the ceiling in the room and is looking downwards at a scene.

There is no current requirement for a symbol of a focal point, but we suggest that it might be useful, to alert users with avatars near it, that avatars are being recorded. An analogy is with laptops, where when the laptop camera is turned on, a light appears next to it, to tell the user that she is being recorded. In a similar way, a room which permits ghost spiders only if they show a focal point can be considered as adhering to a best practice.

If the ghost spider is taking a 360 degree panoramic scan, the focal point might be depicted as (eg) a 360 degree disc.

If a room has multiple ghost spiders, then each might have a different focal length. There is no requirement that the spiders have to have the same focal length.

Instead of a focal point symbol, a ghost spider might just have (eg) a blinking (red) dot, to indicate its presence.

Thus far, we described a ghost spider recording visuals in the room. It might also record audio (that is within “earshot”). This can also be publicised in the icon of the ghost spider. Perhaps by a combination of a focal point symbol (for the recording of visuals) and a blinking light for the recording of audio.

More broadly, the ghost spider has one symbol turned on when visuals are being recorded, and a second symbol turned on when audio is being recorded. What these are can be different for different rooms. But we suggest that to make it easier for users to go between rooms, that the symbols be common across rooms.

Another aspect is when ghost spiders come from different firms. Suppose ghost spider A comes from firm A and ghost spider B comes from firm B. Spider A appears at point (x,y,z) and looks in direction theta at some scene. Spider B appears near (x,y,z) and looks in the same direction or approximately same direction theta. The room can override spider B's location and angle, and put it at the same (x,y,z) and theta as A. The icon for A is altered to have an indicator, like the number 2. This says that 2 ghost spiders (from different firms) are viewing the same scene at the same location and angle. This reduces the visual clutter of having too many spiders. And it reduces the computational load on the room server. For that location, it only has to find 1 view, which is then sent to 2 spiders.

To be explicit. The room can consider spider locations within some variance to be equivalent and the room can then make the locations of such close spiders be the same. What that variance is can be up to the room. Different rooms can have different variances. Similarly, the viewing directions of such close spider locations can also be considered equivalent and then made equal.

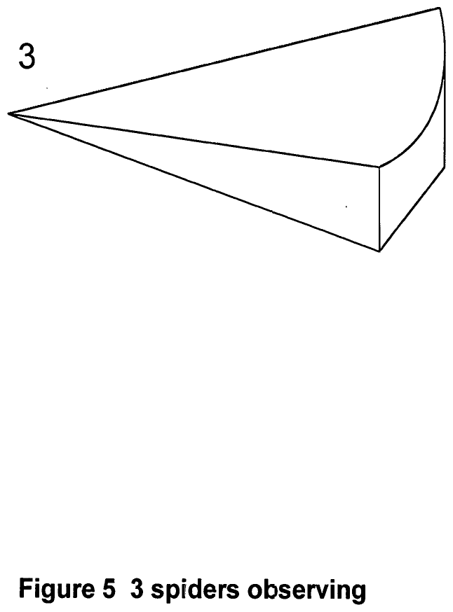

FIG. 5 shows 3 ghost spiders observing a scene. The spiders are from different firms and are all located at the same (x,y,z) and are looking in the same direction. The “3” in FIG. 5 is visible to the avatars, as well as the icon showing the focal point and a representation of the FoV. If the spiders have different FoVs, the FoV shown for all the spiders can be the largest FoV.

Now consider standard avatars in a room. The avatars might be of spiders or not. When an avatar is recording visuals, it might as a matter of best practice or etiquette show an icon in front or above it. Perhaps a blinking dot. And since avatars can record audio, there could be a second symbol to indicate this.

The symbols for recording audio and for recording visuals can be the same for general avatars doing this, and for spiders (ghost or not) doing this. And these symbols might be the same for different rooms.

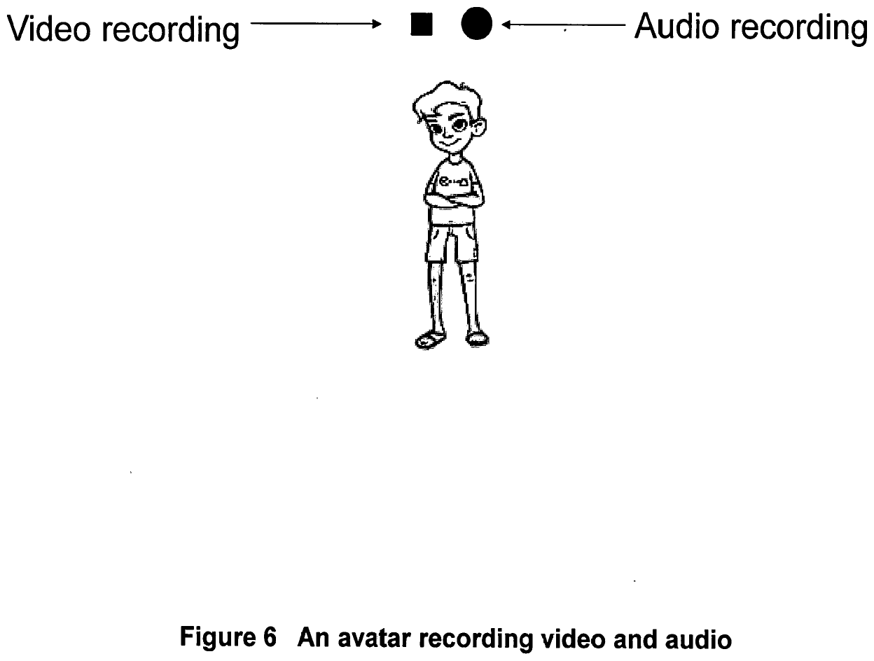

FIG. 6 shows an avatar and 2 symbols appear above him. The black square means he is recording video. The black circle means he is recording audio. The choice of symbols is arbitrary. If the avatar can record haptic data, there can be a third symbol to show that this is happening.

### 7: INSERTING ADS IN SPIDER DATA

Suppose a spider firm becomes prominent in the Metaverse. Its data that it spiders become a de facto record of the rooms in the Metaverse that it visits. A room can inserts ads into the data stream recorded by the spider in the room. It can do this because the visuals (and the audio) recorded by the spider originate in the room.

The room cannot be cut out by the spider. When the spider gets visuals, these are first made by the room, in the FoV of the spider. This also holds true if the spider is recording visuals from the FoV of an ordinary avatar. Whether the visuals are meant for the spider or a non-spider avatar, they have to be made by the room. This is what VR means.

Suppose the spider gets 30 minutes of a visual feed. The room can delete, say, starting at the 3 minute mark and extending to the 4 minute mark in the feed. It can replace this with a 60 second ad from a third party advertiser. This resulting spliced feed is then sent to the spider.

(A variant is where in the visual feed, a 60 second ad is inserted at the 3 minute mark, so that the spider gets 31 minutes, of which the entire “real” feed is 30 minutes.)

The spider firm can detect the 1 minute ad and delete it in the data stream. In turn, the room can detect the deletion. Because the data stream is made available to general users of the spider. And the room, as a general user, can watch the spider's data stream.

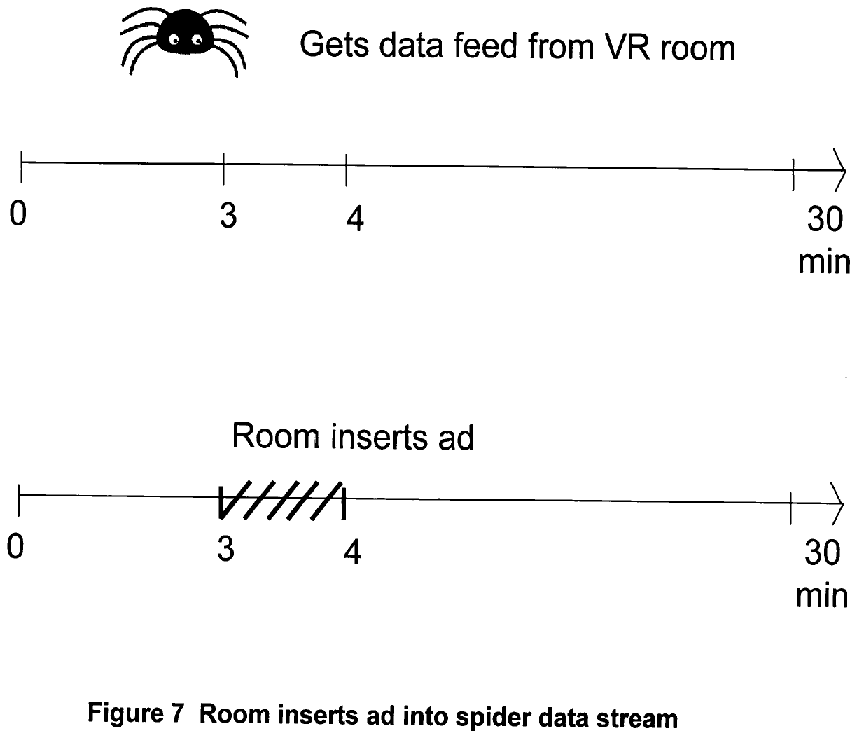

The room then refuses to permit the spider future access to the room. The room can insist on being able to sell ads that appear in the spider data. Unlike what happened in the Web, where GOGGLE used its dominance of search to become the largest ad network in the world, and individual websites became inferior compared to GOGGLE. Now there is a more balanced relationship between a Metaverse room and a Metaverse spider. See FIG. 7.

The data stream received by the spider will have a (slight) delay compared to what the avatars in the room see, because of the operations done on the data stream to insert an ad. But the data stream made available by the spider to its general users, who are mostly viewing the stream on the Web or on mobile, is rarely real time. So the delay made by the room's editing should not be a problem.

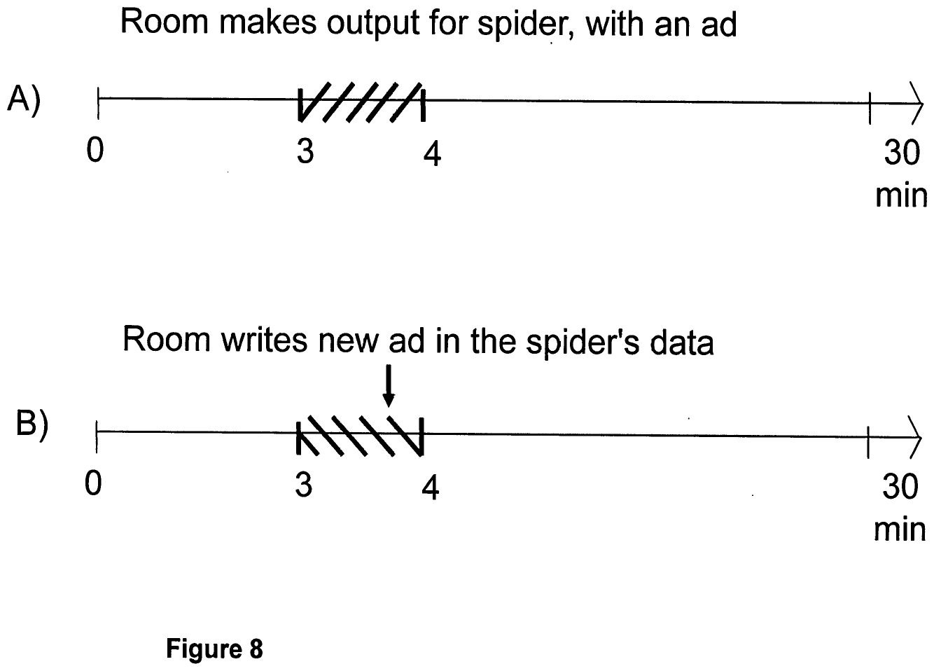

Now assume the spider and room accept that the room can insert a 1 minute ad at the 3 minute mark. And the spider has a 30 minute feed of the room, with the ad. The spider can let the room update the 1 minute ad with any new ad of the same length, even if the spider does not re-spider the room. The room directly inserts into the stored data at the spider via access provided by the spider. See FIG. 8. In step (A), the room makes the original data for the spider. In step (B), the room overwrites the data at the spider, replacing the original ad with a new ad at the time slot of the original data. Step (B) can happen at a much later time than step (A).

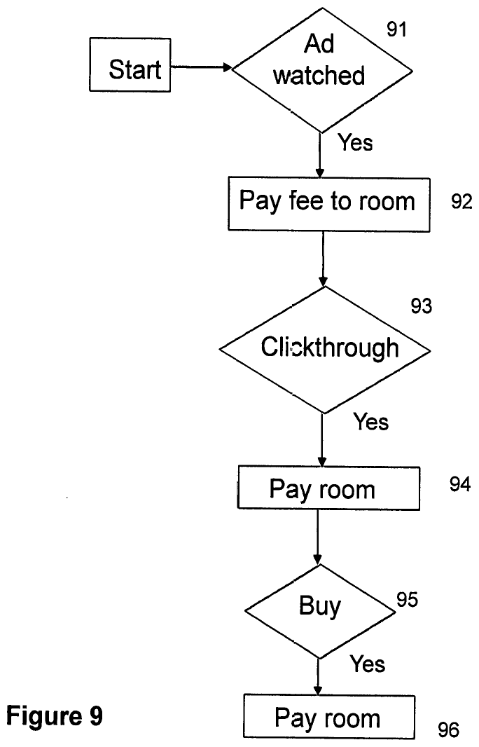

FIG. 9 is a flow chart of an advertiser interacting with a user who watches an ad shown by the spider server, where the ad comes from the room. An advertiser supplies an ad to the room. The ad might be watched either by a user in the room or by a user who is looking at search results presented by the spider.

Step 91 asks if the ad is watched. The ad can use images coming from the advertiser's machine. An image can have a label with a code indicating the room. When the ad is loaded from the advertiser, this tells the advertiser that the image was shown by the room. Or by the spider using an ad it got from the room. The advertiser can pay the room a (small) fee in step 92.

If the ad is clickable and the user clicks it in step 93, the advertiser can pay the room for a clickthrough in step 94. Going further, if the watcher buys something (step 95), the advertiser can pay the room in step 96.

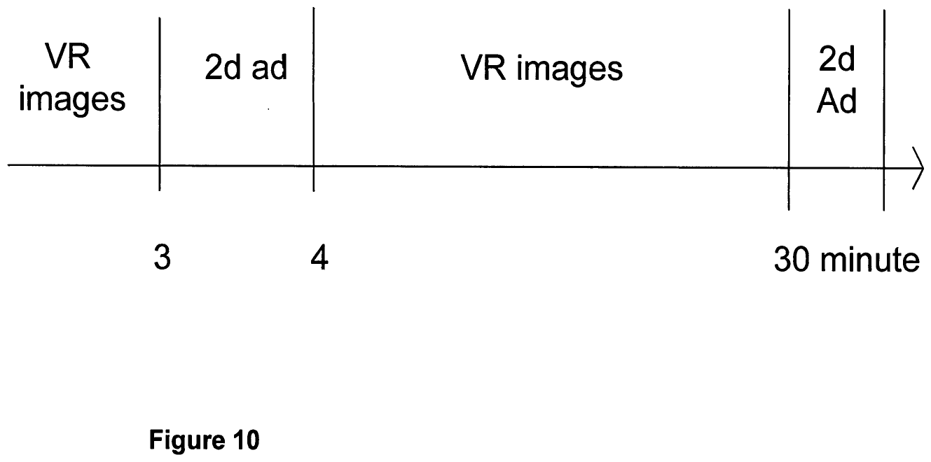

FIG. 10 is a timeline for a user in the room to watch. Before minute 3, and between minutes 4 and 30, the user sees various VR images in her FoV, presented by the room. But between minutes 3 and 4 and for some time after minute 30, she is shown standard ads. She might watch these against a flat background, like watching an ad in a Web browser. She can do this on 1 screen of her HUD rig, that screen being just for 1 eye. In our previous co-submission, we described how this can be done.

The room might be able to directly send to the spider server an ad whose length might be different than an ad sent earlier by the room. The latter ad could be 1 minute, while the new ad might be 1 minute 20 seconds. The new ad could replace the old ad.

The feed received by the spider from the room can be in 3D, because the spider's PoV can be for 2 eyes getting input. Whereas the ad that the room gets from an advertiser can just be for showing on 1 flat electronic screen. But some ads can be in 3D if an advertiser sees a large enough market. One reason for the feed having 3D video is that this can be seen by users with 3D devices. They can watch in 3D what they might have seen if they were in the Metaverse. Giving incentive for people to buy hardware to do so.

### 8: ANTISPAM

When a user sees (and hears) an ad shown in the room's data stream, antispam methods can be used against it. In the spam wars, an important method was found of using a blacklist of spammer domains. A link in suspected spam would be compared to the blacklist. If the link had a domain in the list, the message would be considered spam and discarded.

In a similar way, if the data received by the spider has an ad and the latter has a link in the blacklist, the spider can tell the room. The room can ask the advertiser for a different ad, that does not have that domain. Or the room can ask a different advertiser.

Usually when a blacklist is used, it is against emails and other written messages. Here, an ad might have a spoken component. This can be reduced to written form by the spider server, and this form is then compared to a blacklist.

We claim:

1. A method of combating spam in a room in the Metaverse;
a user with an Augmented Reality/Virtual Reality (AR/VR) apparatus (rig) going to the room;
the user using a first avatar;
the user picking an option in the rig, for where to go in the room;
the rig interacting with the room;
where one of the following is done:
[b] the option being to put the first avatar in a crowd, the room finding a group of one or more avatars, the room putting the first avatar with the group,
[d] the option being to put the first avatar near other avatars wearing a given type of clothing, the room finding such a group of avatars, the rig putting the first avatar with the group,
[e] the option being to put the first avatar near other avatars, none wearing a given type of clothing, the room finding such a group of avatars, the room putting the first avatar with the group,
the room showing video to the group;
several links in the video having domains in a spam blacklist used by the first avatar;
the first avatar informing the group;
one or more avatars of the group not watching those portions of the video.

2. The method of claim 1, where;
the user had been to the room at an earlier time;
at the present time, the user picked an option of a location where the user landed in the room at the earlier time;
the room putting the first avatar at or near the location.

3. The method of claim 1, where:
the user had been to the room at an earlier time;
at the present time, the user picked an option of the last location in the room of the user the earlier time;
the room putting the first avatar at or near the last location.

4. The method of claim 1, where:
the rig can simulate touch of an object;
at an earlier time, the first avatar touched an object in the room;
at the earlier time, the room recorded a location of the first avatar;
at the present time, the user picked an option of where the first avatar experienced the touch;
the room putting the first avatar at or near the location.

5. The method of claim 1, where:
at an earlier time, the user recorded at a location in the room, an image of the location;
at the present time, the user picks the image;
the room putting the first avatar at or near the location designated by the image.

6. The method of claim 5, where:
the image was recorded from the Field of View of the user.

7. The method of claim 5, where:
the image was a stereoscopic image.

8. The method of claim 1, where:
at an earlier time, the user recorded audio at a location in the room;
at the present time, the user picked the audio;
the room putting the first avatar at the location.

9. The method of claim 8, where:
the audio was furnished by the room;
the audio was produced by an object or a second avatar at the location.

10. A system of a VR room and a spider;
the spider visiting the room;
the spider recording images and sounds in the room;
the room showing one or more icons representing the spider;
a first icon representing a focal point of the spider;
the first icon optionally also representing the Field of View of the spider;
a second icon indicating that audio near the spider is being recorded.

11. The system of claim 10, where there are spiders in the room;
the spiders being made by different firms;
the spiders recording an event;
the room determining that the spiders are sufficiently close to each other, such that:
[a] the room moves the spiders to being at the same coordinates,
[b] the room sets the directions of view of the spiders to be the same;
the room setting a common icon for all the spiders;
the room setting a visible number near the coordinates of the spiders;
the number being a count of the spiders at those coordinates.

12. A method of a VR room interacting with a spider;
the spider being in the room;
the room makes visual and audio data at a location of the spider, using a Point of View of the spider;
the room gets a first ad from a first advertiser;
the room inserts the first ad into the data;
the room sends the data to the spider;
the spider stores the room data at a server;
the room data being viewed by a first user;
the ad in the room data is seen by the first user;
the first advertiser pays the room.

13. The method of claim 12, where:
the first user clicks on the first ad in the room data;
the first advertiser pays the room.

14. The method of claim 13, where:
the first user makes a purchase;
the first user pays the first advertiser;
the first advertiser pays the room.

15. The method of claim 12, where:
the room gets a second ad from the first advertiser;
the room sends the second ad to the server;
the server replaces the first ad in the room data with the second ad;
the second ad in the room data is seen by a second user;
the first advertiser pays the room.

16. The method of claim 15, where:
the second user clicks on the second ad in the room data;
the first advertiser pays the room.

17. The method of claim 16, where:
the second user makes a purchase;
the second user pays the first advertiser;
the first advertiser pays the room.

18. The method of claim 12 where:
the room gets a third ad from a second advertiser;
the room sends the third ad to the server;
the server replaces the first ad in the room data with the third ad;
the third ad in the room data is seen by a third user;
the second advertiser pays the room.

19. The method of claim 18, where:
the third user clicks on the third ad in the room data;
the second advertiser pays the room.

20. The method of claim 19, where:
the third user makes a purchase;
